(19) United States
(12) Patent Application Publication
(10) Pub. No.: US 2025/0013997 A1
(43) Pub. Date: Jan. 9, 2025

(54) CENTRAL PAYMENT SYSTEM FOR PERIODIC MERCHANT SETTLEMENT

(71) Applicant: Visa International Service Association, San Francisco, CA (US)

(72) Inventors: Fahim AHMED, Singapore (SG); Nashita GUNTAGULI, Singapore (SG); Si Ying ONG, Singapore (SG)

(73) Assignee: Visa International Service Association, San Francisco, CA (US)

(21) Appl. No.: 18/346,370

(22) Filed: Jul. 3, 2023

(51) Int. Cl. G06Q 20/08; G06Q 20/10; G06Q 20/38; G06Q 20/40

(52) U.S. Cl. CPC G06Q 20/0855; G06Q 20/102; G06Q 20/389; G06Q 20/4037

(57) ABSTRACT

Method and system for initiating a settlement process for a merchant, based on accumulated customer transactions in a transaction period, are provided. The system provides a configurable interface for the merchant that allows for the merchant to manually settle customer debts for accumulated transaction over an agreed period of time or designate an automatic settlement date. A central payment server receives a request to initiate a settlement process between an acquirer system associated with the merchant and an issuer system associated with a customer. The central payment server establishes a payment system that guarantees the settlement of all transactions for the merchant, through an assured agreement between the customers and the issuer systems.

### TECHNICAL FIELD

A method and system for initiating a settlement process between an acquirer system associated with a merchant and an issuer system associated with a customer. A central payment server stores a central ledger that records all transactions associated with a merchant in a transaction period. The merchant receives a guaranteed settlement based on an assured agreement between the customers and the issuer systems, for all consolidated transaction in a transaction period.

### SUMMARY

In one aspect, the present disclosure provides a method for settling a central ledger in a central payment system, the method comprising: determining, by a computing system, a settlement type associated with a merchant device; determining, by the computing system, a settlement date associated with the settlement type, wherein the settlement date is within a settlement window associated with a transaction period for the merchant device; determining, by the computing system, a set of transactions made in the transaction period, wherein the set of transactions are associated with an issuer system; transmitting, by the computing system, a settlement request to the issuer system, wherein the settlement request prompts the issuer system to push funds to an acquirer system associated with the merchant device; receiving, by the computing system, a confirmation message from the acquirer system that they have received funds associated with the set of transactions, from the issuer system; updating, by the computer system, a transaction status for the set of transactions in a central ledger, wherein the transaction status is updated in response to the confirmation message received by the acquirer system; and notifying, by the computer system, the merchant device that funds were received by the acquirer system associated with the set of transactions.

In another aspect, the present disclosure describes a method for settling a central ledger in a central payment system, the method comprising: receiving, by a computing system, a settlement date from a merchant device, wherein the settlement date is within a settlement window associated with a transaction period for the merchant device; determining, by the computing system, a set of transactions made in the transaction period, wherein the set of transactions are associated with an issuer system; transmitting, by the computing system, a settlement request to the issuer system, wherein the settlement request prompts the issuer system to push funds to an acquirer system associated with the merchant device; receiving, by the computing system, a confirmation message from the acquirer system indicating receipt of funds associated with the set of transactions, from the issuer system; updating, by the computing system, a transaction status for the set of transactions in the central ledger, wherein the transaction status is updated in response to the confirmation message received from the acquirer system; and notifying, by the computer system, the merchant device that funds were received by the acquirer system associated with the set of transactions.

In yet another aspect, the present disclosure describes a method for settling a central ledger in a central payment system, the method comprising: receiving, by a computing system, transaction records associated with transaction requests made by a plurality of customer devices; recording, by the computing system, the transaction records in the central ledger; performing, by the computing system, a periodic settlement query on the central ledger based on a predetermined transaction period associated with a merchant identifier of a merchant device; transmitting, by the computing system, a settlement request to a plurality of issuer systems corresponding to the plurality of customer devices, wherein the settlement request is based on the periodic settlement query; receiving, by the computing system, a settlement confirmation from an acquirer system corresponding to the merchant device, wherein the settlement confirmation indicated that settlement funds were deposited in an account associated with the merchant device; and updating, by the computing system, the central ledger associated with the plurality of customer devices based on the settlement confirmation.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 shows a central payment system comprising a plurality of merchant devices, a plurality of acquirer systems, a central payment server, a plurality of issuer systems, and a plurality of customer devices, according to at least one aspect of the present disclosure.

FIG. 2 shows an example database of customer information and merchant information, stored at the central payment server, according to at least one aspect of the present disclosure.

FIG. 3 shows a central payment system from the perspective of a single merchant, according to at least one aspect of the present disclosure.

FIG. 4 shows an example database at the central payment server, according to at least one aspect of the present disclosure.

FIGS. 5A and 5B show example query reports, generated by the central payment server for the settlement of merchant accounts, according to at least one aspect of the present disclosure.

FIG. 6 shows a logic flow diagram of an example transaction flow, according to at least one aspect of the present disclosure.

FIG. 7 shows an example timeline of a buy now pay later service comprising a first transaction period, a settlement period, and a default auto settlement date, according to at least one aspect of the present disclosure.

FIG. 8 shows a logic flow diagram of an auto-settlement process, according to at least one aspect of the present disclosure.

FIG. 9 shows a logic flow diagram of a merchant triggered manual settlement process, according to at least one aspect of the present disclosure.

FIG. 10 shows a graphical user interface of a buy now pay later application configured for a merchant account on a user device, according to at least one aspect of the present disclosure.

FIG. 11 shows an example notification, received by a merchant through the buy now pay later application, according to at least one aspect of the present disclosure.

FIGS. 12-14 show example notifications, received by a merchant through a buy now pay later application, in response to a manual settlement request, according to at least one aspect of the present disclosure.

FIG. 15 shows a graphical user interface of a buy now pay later application configured for a merchant account on a user device, and displays a listing of all customer transaction made in a predefined period, according to at least one aspect of the present disclosure.

FIGS. 16 and 17 show a graphical user interface of a buy now pay later application configured to enter transaction information for a customer transaction, according to at least one aspect of the present disclosure.

FIGS. 18 and 19 show a graphical user interface of a buy now pay later application configured to receive a transaction request by a customer, and authorize the transaction request, according to at least one aspect of the present disclosure.

FIGS. 20 and 21 show a graphical user interface of a buy now pay later application configured to complete a pay now transaction, by a customer, according to at least one aspect of the present disclosure.

FIGS. 22 and 23 show a graphical user interface of a buy now pay later application configured to display a notification received by a customer in response to a transaction settlement, according to at least one aspect of the present disclosure.

FIG. 24 is a block diagram of a computer apparatus with data processing subsystems or components, according to at least one aspect of the present disclosure.

FIG. 25 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments or aspects, an acquirer may be a financial institution, such as a bank.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g, a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “merchant application” may include any application associated with a relying party to a transaction. For example, a merchant mobile application may be associated with a particular merchant or may be associated with a number of different merchants. In some embodiments or aspects, the merchant mobile application may store information identifying a particular merchant server computer that is configured to provide a sales environment in which the merchant server computer is capable of processing remote transactions initiated by the merchant application. Further, the merchant mobile application may also include a general purpose browser or other software designed to interact with one or more merchant server computers. In some cases, the merchant mobile application may be installed in the general purpose memory of a user device and thus, may be susceptible to malicious attacks.

As used herein, a “customer device” may include a “computing device” or “mobile device” and may comprise any electronic device that may be operated and/or transported by a user, which also may provide remote communication capabilities to a network and may be referred to as a mobile device and may comprise a fixed device. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A computing device may comprise any suitable hardware and software for performing such functions, and may also include multiple devices or components (e.g. when a computing device has remote access to a network by tethering to another device—e.g., using the other device as a modem—both devices taken together may be considered a single mobile device). A computing device also may comprise a verification token in the form of, for instance, a secured hardware or software component within the computing device and/or one or more external components that may be coupled to the mobile device. A detailed description of an exemplary mobile device is provided below.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

As used herein, “short range communication” or “short range wireless communication” may comprise any method of providing short-range contact or contactless communications capability, such as RFID, Bluetooth™, infra-red, or other data transfer capability that can be used to exchange data between a payment device and an access device. In some embodiments or aspects, short range communications may be in conformance with a standardized protocol or data transfer mechanism (e.g., ISO 14443/NFC). Short range communication typically comprises communications at a range of less than 2 meters. In some embodiments or aspects, it may be preferable to limit the range of short range communications (e.g. to a range of less than 1 meter, less than 10 centimeters, or less than 2.54 centimeters) for security, technical, and/or practical considerations. For instance, it may not be desirable for a POS terminal to communicate with every payment device that is within a 2 meter radius because each of those payment devices may not be involved in a transaction, or such communication may interfere with a current transaction involving different financial transaction devices. Typically, the payment device or the access device also includes a protocol for determining resolution of collisions (e.g., when two payment devices are communicating with the access device simultaneously). The use of short range communications may be used when the merchant and the consumer are in close geographic proximity, such as when the consumer is at the merchant's place of business.

As used herein, the term “central payment server” may refer to an entity that receives transaction authorization requests from merchants or other entities and provides guarantees of payment, in some cases through an agreement between the merchant and an issuer. For example, a central payment server may include a payment network, such as Visa®, MasterCard®, American Express®, or any other entity that processes transactions. As used herein “central payment server” may refer to one or more systems operated by or operated on behalf of a central payment server, such as executing one or more software applications associated with central payment server. In some non-limiting embodiments or aspects, a central payment server may include one or more server computers with one or more processors and, in some non-limiting embodiments or aspects, may be operated by or on behalf of a central payment service provider.

In various aspects, the present disclosure describes a method and system for initiating and executing a settlement process for a merchant, based on multiple customer transactions made during a transaction period. The system provides a configurable interface for the merchant that allows for the merchant to manually or automatically initiate the settlement of the accumulated transactions, during the settlement period. The customer authorizes the settlement at the time each transaction is made during the transaction period, and no further input is required by the customer at the time of settlement. The configurable interface allows the merchant to initiate the settlement for all customers, select customers, or select transactions made during the transaction period. The merchant may also configure the settlement process to automatically initiate at the same time in each transaction/settlement cycle/period, or designate an automatic settlement date, without any merchant's input.

In various aspects, the settlement process is performed by a central payment server that receives a settlement request from the merchant, and initiates the settlement process between an acquirer system, associated with the merchant, and an issuer system, associated with a customer. The central payment server provides a “buy now, pay later” payment system that guarantees the settlement of all customer transactions for the merchant. In order for customers to participate in the “buy now, pay later” payment system, the customer is required to engage in an assured agreement with the issuer systems. Accordingly, the issuer system of each respective customer guarantees all settlement payments necessary to cover all customer transactions that were authorized during a transaction period.

In various aspects, the merchant may be a brick-and-mortar retailer that allows customers to purchase items from the retail location through a buy now pay later application on the customer's mobile device. At the time of the transaction, the customer authorizes a settlement payment at a future date. The customer may engage in multiple transactions with the merchant throughout a predetermined transaction period. At the end of the transaction period, the merchant can pull or trigger a single payment for all transactions made during the transaction period that pass from the issuer system associated with the customer(s) to the acquirer system associated with the merchant. The central payment server hosts a central ledger that records all authorized transactions between merchants and customers. The central ledger may be accessed by any customer or merchant to view real-time transaction information, made by the party viewing, during a specific or customized period of time. However, the central payment server may restrict transaction records to only those related to the accessing customer or merchant.

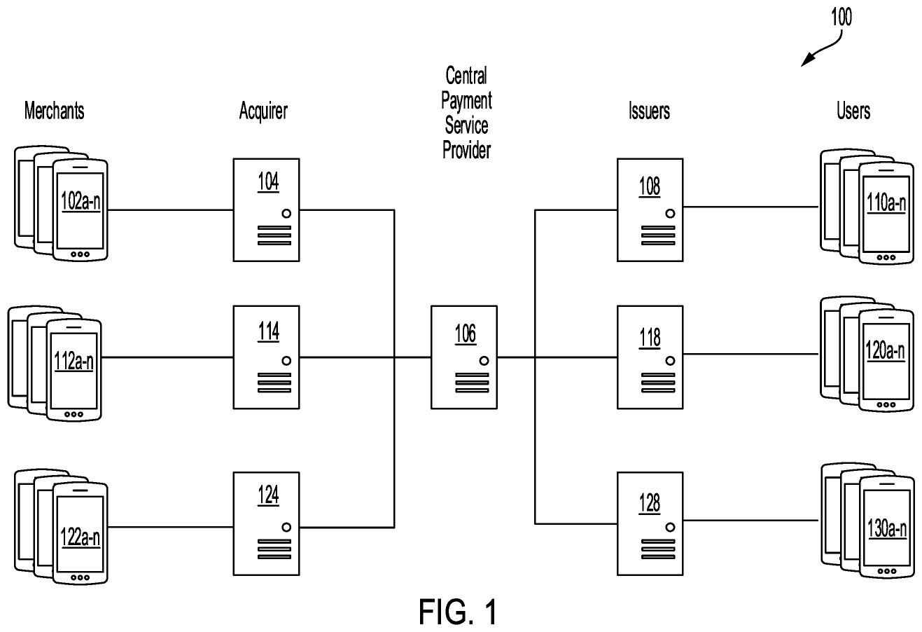

FIG. 1 shows a central payment system 100 comprising a plurality of merchant devices 102a-n, 112a-n, 122a-n, a plurality of acquirer systems 104, 114, 124, a central payment server 106, a plurality of issuer systems 108, 118, 128, and a plurality of customer devices 110a-n, 120a-n, 130a-n, according to at least one aspect of the present disclosure. The central payment system 100 supports a plurality of different acquirer systems 104, 114, 124 as a financial institution (e.g., bank) associated with different merchants 102a-n, 112a-n, 122a-n. FIG. 1 further shows the merchant devices 102a-n associated with the acquirer 104; the merchant devices 112a-n associated with the acquirer system 114; and the merchant devices 122a-n associated with the acquirer system 124. Similarly, each customer device 110a-n, 120a-n, 130a-n in the central payment system 100 may elect to use a different issuer system 108, 118, 128 as a financial institution (e.g., bank or credit provider). FIG. 1 further shows a plurality of different customers 110a-n associated with the issuer system 108; a plurality of different customers 120a-n associated with the issuer system 118; and a plurality of different customers 130a-n associated with the issuer system 128. Additionally, a single customer 110a may have multiple different accounts with more than one issuer system 108, 118, 128.

Prior to participation in the “buy now, pay layer” payment system, each participating merchant device 102a-n and customer device 110a-n may be required to register with their respective financial institutions (e.g., acquirer systems 104a-n, issuer systems 108a-n) or the central payment server 106. In one example, the customer device 110a-n and merchant device 102a-n are required to download a buy now pay later (BNPL) application. The first time a customer device or merchant device opens the BNPL application, they may be prompted to sign into the application or register by creating a new account. The BNPL application may allow the merchant device 102a-n and the customer device 110a-n to register by using their existing credentials with their respective acquirer systems 104a-n and issuer systems 108a-n. During the registration processes, each merchant device 102 and customer device 110 is assigned a unique identifier that is used by the central payment server 106 to associate a transaction record with the respective party (e.g., merchant device, customer device). In one aspect, the registration process for the merchant device 102a generates a QR code that provides a unique merchant ID, associated with merchant device 102a, and the QR code is scanned by the customer device 110a every instance of a purchase. Upon completion of the registration process, user information associated with the merchant device 102a and the customer device 110a is stored on the central payment server 106.

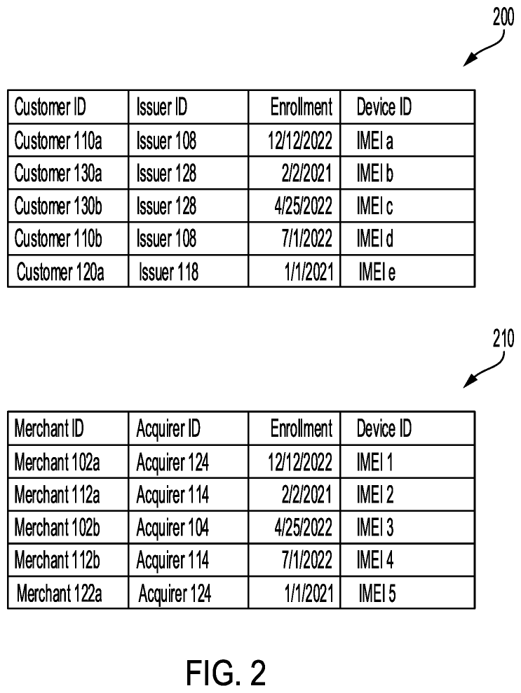

FIG. 2 shows an example database of user information comprising a customer information database 200 and a merchant information database 210, stored at the central payment server 106, according to at least one aspect of the present disclosure. The central payment server 106 may receive the user information directly from the merchant device 102a or the customer device 110a upon completion of the registration process, or the central payment server 106 may receive the user information from the issuer systems 108a-n and acquirer systems 104a-n.

In various aspects, the customer registration process establishes an agreement between the customer devices 110a-n and the issuer systems 108. The agreement allows the issuer systems 108 to guarantee the settlement amounts for all authorized transaction made to the merchant devices 102a-n. In various aspects, if a customer account with an issuer system 108 has insufficient funds to cover the total settlement amount at the time of the settlement process, the issuer system 108 will cover the total settlement amount and establish an alternative payment plan with the customer 110a-n until the balance associated with the settlement amount is paid in full. The issuer system 108 may impose restrictions on the future transactions performed by the customer device 110a until the balance is paid.

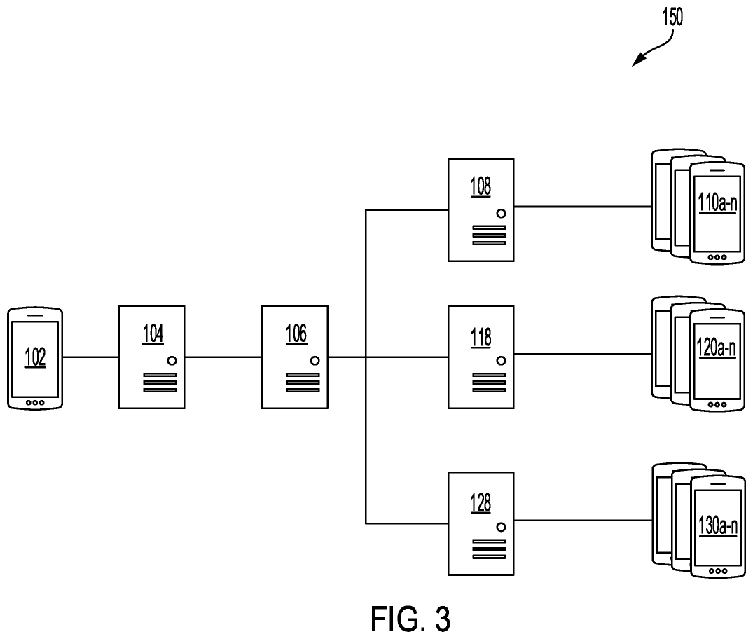

FIG. 3 shows a central payment system 150 from the perspective of a single merchant device 102a, according to at least one aspect of the present disclosure. The central payment system 150 comprises a merchant device 102a associated with an acquirer system 104, and a plurality of customers 110a-n, 120a-n, 130a-n, associated with respective issuer systems 108, 118, 128.

In one example, a customer device 110a performed 12 transactions with a merchant device 102a during a transaction period, between January 22 and February 21. The transaction total for the transaction period is $110. At the time that each transaction is made with the merchant device 102a, the customer device 110a authorizes the future payment to the merchant device 102a at a merchant designated settlement date. In various aspects, the merchant designated settlement date may include the last day of the month (e.g., February 28) or a predetermined date after February 21, the end of the transaction period. On February 21, the customer device 110a has only $5 associated with the customer account with the issuer system 108. However, on February 24, the customer account receives a deposit from their employer, and $500 is added to the customer account at the issuer system 108. On February 28, issuer system 108 receives a request to settle the transaction total and $110 is pulled from the customer account associated with customer device 110a, at the issuer system 108.

In another example, the customer device 110a performed the same 12 transaction totaling $110 for transaction period January 22-February 21. Again, the customer device 110a authorized the merchant device 102a to settle the transaction total on February 28. However, customer account associated with the customer device 110a is not scheduled to receive a deposit until March 1. The issuer system 108 covers the settlement payment on February 28, according to the authorization agreement by the customer device 110a, and the issuer system 108 pulls funds from the customer account on March 1, when a deposit is made by their employer.

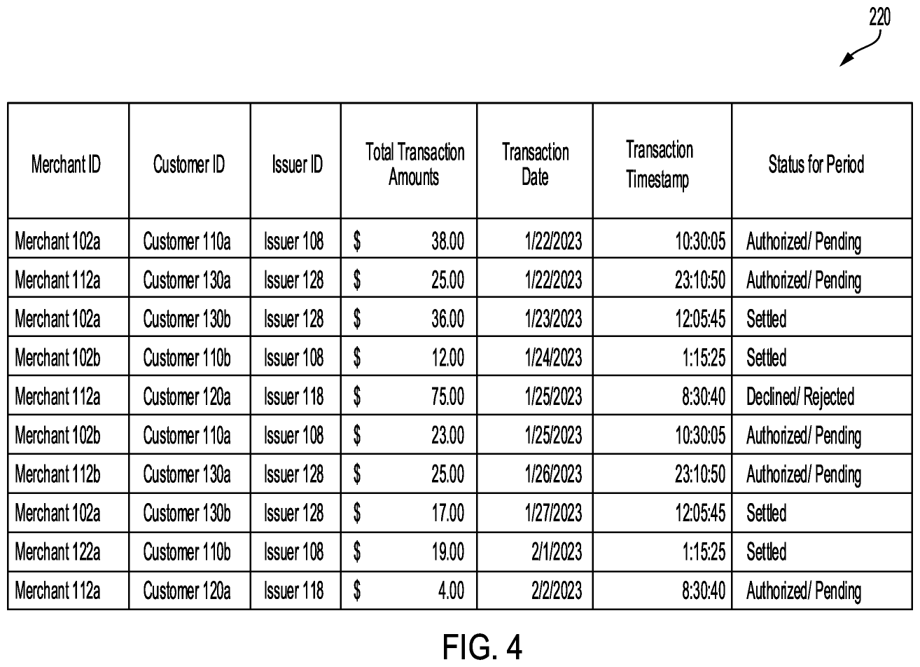

FIG. 4 shows an example database at the central payment server 106, according to at least one aspect of the present disclosure. The central payment server 106 may store transaction information in a central ledger 220 for all customer devices 110a-n and all merchant devices 102a-n. In various aspects, once a customer device 110a authorizes a transaction, the central payment server 106 receives a transaction record from an issuer system 108 and adds the transaction record as a new entry in the central ledger 220. The central payment server 106 updates the transaction status in the central ledger 220 to authorized/pending settlement, to reflect the current status of the transaction (e.g., authorized, pending settlement, rejected, settled), throughout the lifecycle of the transaction. Additionally, the central payment server 106 may send the merchant device 102a a confirmation message that the transaction record was authorized by the issuer system 108 and stored to the central ledger 220 as a new transaction record. The confirmation message indicates to the merchant device 102a that the transaction was successfully authorized and the user may leave the retail location with their purchase.

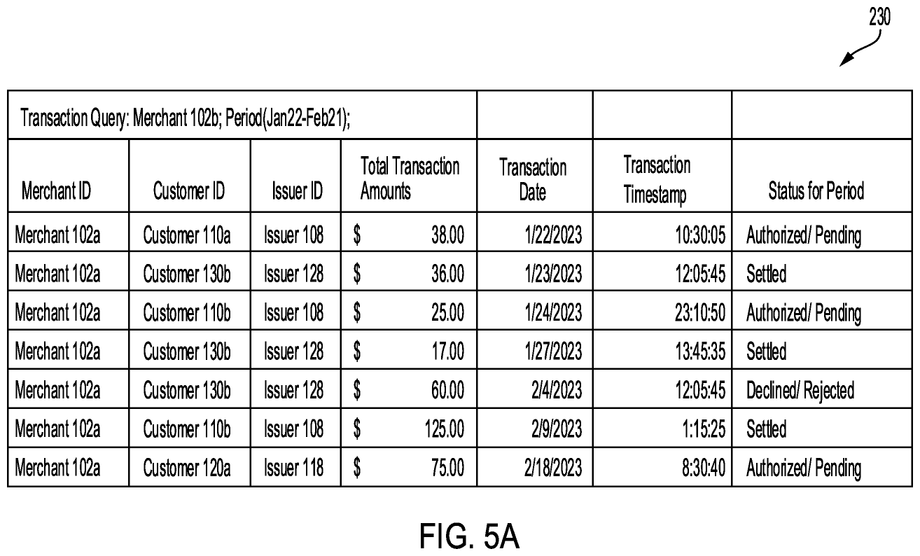

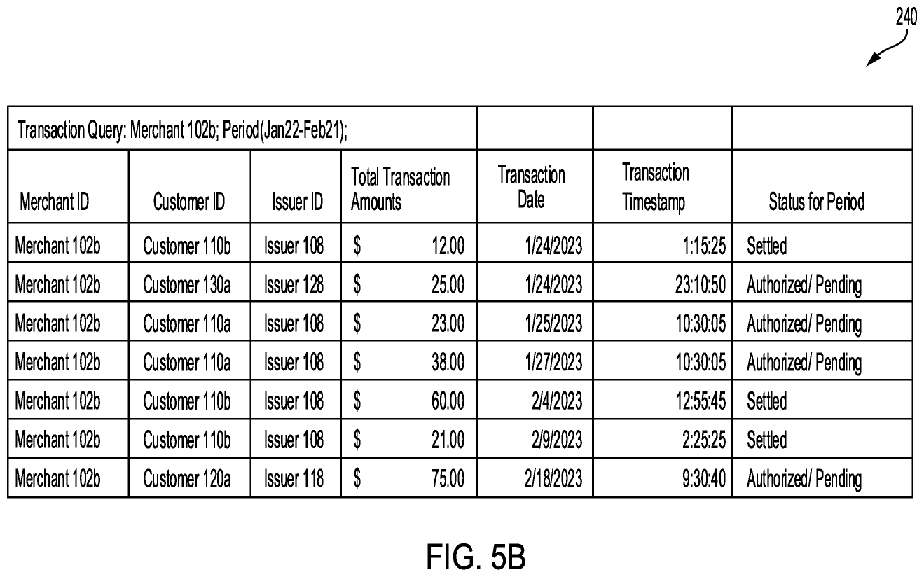

FIGS. 5A and 5B shows example query reports, generated by the central payment server 106 for the settlement of merchant accounts, according to at least one aspect of the present disclosure. The customer device 110a and merchant device 102a may request transaction reports from the central payment server 106. The request may comprise a query of the central ledger 220. In various aspects, the central ledger 220 may be display on the BNPL application through a queryable interface. The queryable interface may allow a merchant 102 or customer 110 to generate a transaction report according to a non-exhaustive list of fields including merchant, customer, issuer, acquirer, predetermined transaction period, custom transaction period, etc. Additionally, the center payment server 106 may be configured to automatically generate merchant specific transaction reports at the end of each transaction period.

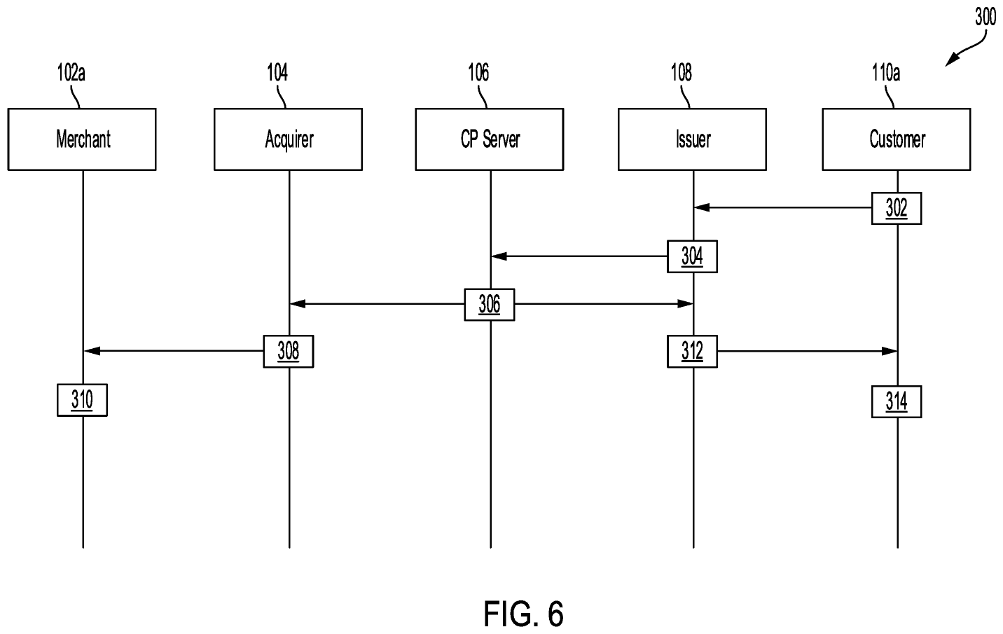

FIG. 6 shows a logic flow diagram of an example transaction 300, according to at least one aspect of the present disclosure. According to one aspect of the transaction 300, the customer device 110a indicates a selection 302 of goods or services from the merchant retail location and accesses the BNPL application to make a purchase. In one aspect, using the customer device 110a, a user scans a merchant QR code to initiate the purchase through the BNPL application. The merchant QR code may be a static or dynamic QR code that comprises a merchant unique ID. If the customer device is not registered with the central payment system or the BNPL application is not installed on the customer device 110a, the QR code may be scanned with a camera application in the customer device 110a and the customer device may display a URL link to download the BNPL application. Additionally, the QR code may open or launch a BNPL application that is already present on the customer device 110a. The customer may be prompted to enter banking credentials or other account information to access the customer account within BNPL application. Once the BNPL application is deployed on the customer device 110a, the BNPL application may display a message that prompts the customer to enter transaction information, including the transaction amount associated with the purchase, for a static QR code. In the case of a dynamic QR code, the merchant may enter the transaction information before the customer scans the code, and the transaction information is automatically associated with the dynamic QR code. Before the transaction information is sent to the issuer system 108, the transaction information may be authenticated within the BNPL application. The transaction information may include the transaction amount, merchant ID, and the date and time (e.g., timestamp) that the transaction request was initiated by the customer device 110a. In another aspect, a transaction may be initiated by an interaction between the customer device 110a and merchant device 102a, through a short-range wireless communication protocol (e.g., near-field communication, Bluetooth, zigbee, etc.).

In one aspect of the transaction 300, the issuer system 108 receives 304 the transaction information through an API with the BNPL application and authorizes the transaction request based on the customer account information with the issuer system 108. For example, the issuer system 108 may verify that the customer account has not exceeded a credit limit. Once the transaction information is successfully verified by the issuer system 108, the issuer system 108 creates a transaction record and sends the transaction record to the payment network.

In one aspect of the transaction 300, the central payment server 106 receives 306 the transaction record and stores the transaction record in a central ledger 220, with all merchant and customer transaction records. The central ledger 220 reflects all transaction records, and allows the customers and merchant transaction information to be immediately accessible in the BNPL application, in real-time. In one aspect of the transaction 300, the central payment server 106 notifies 308 the acquirer system 104 that the transaction request was authorized and a transaction record was stored in the central ledger 220, associated with the transaction request. In one aspect of the transaction 300, the acquirer system 104 notifies 310 the merchant device 102a that the transaction request was authorized and a transaction record was stored in the central ledger 220 for the transaction request. In one aspect of the transaction 300, the issuer system 108 sends 312 a confirmation message to the customer device 110a, that the transaction request was authorized and stored in the central ledger. In one aspect of the transaction 300, the customer device 110a displays 314 the confirmation and allows the customer device 110a to access a list of transactions in the BNPL application.

In various aspects, the merchant device 102a may set a default settlement type during the registration of a merchant account for the BNPL application. The merchant account may be directly linked to the acquirer system 104 and may allow the merchant device 102a to reconfigure the settlement type at any time through the BNPL application. The merchant device 102a may select the settlement type as an auto-settlement or a manual settlement. For auto-settlement, the settlement process is automatically triggered without any action by the merchant device 102a. The settlement date of auto-settlement may be selected by the merchant device 102a, as any date within the settlement window/period, or may be automatically set by the central payment server 106 (e.g., the last day of the month). For manual settlement, the merchant device 102a may manually initiate the settlement process and the money transfer will occur on the same day that the settlement is performed, through a request in the BNPL application.

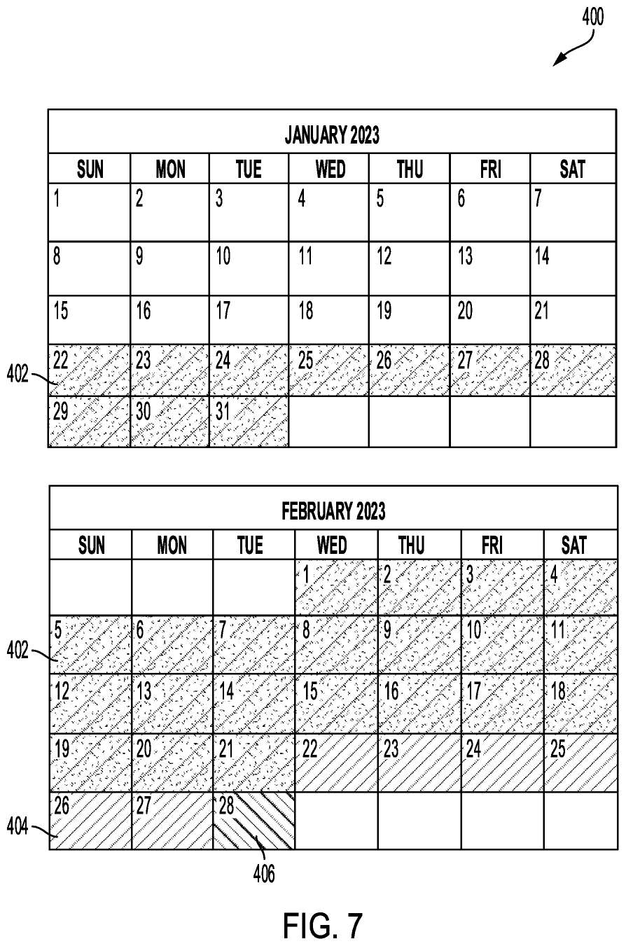

FIG. 7 shows an example timeline 400 of a buy now pay later payment system comprising a first transaction period 402, a settlement period 404, and a default auto settlement date 406, according to at least one aspect of the present disclosure. In this example, the first transaction period 402 is January 22 (e.g., 01/22/2023 at 00:00:01)-February 21 (e.g., 02/21/2023 at 24:00:00). In one example, immediately following the close of the transaction period 402, the settlement window 404 opens for settlement transactions. In this example, the settlement window 404 includes dates between February 22 and February 28. In one example, the merchant device 102a may select an auto-settlement date from any date within the settlement window 404. The auto-settlement date may be configured by the merchant device 102a as a relative date such as 2 days after the end of transaction period 402 or may be a static date such as the 24 of each month. In another example, the central payment server 106 automatically selects a date within the settlement window 404 to initiate the auto-settlement. In another example, the merchant device 102a manually initiates a settlement request on the current day (e.g., the date the request is made), within the settlement window 404. If the merchant account is configured for manual settlement, it is the last day in the settlement window 404, and the merchant device 102a has not initiated a manual settlement, then the central payment server 106 may automatically initiate a default settlement on a default auto-settlement date 406 (e.g., February 28, last day in the period, last day of the month). The default auto-settlement date 406 is the last date in the settlement window 404.

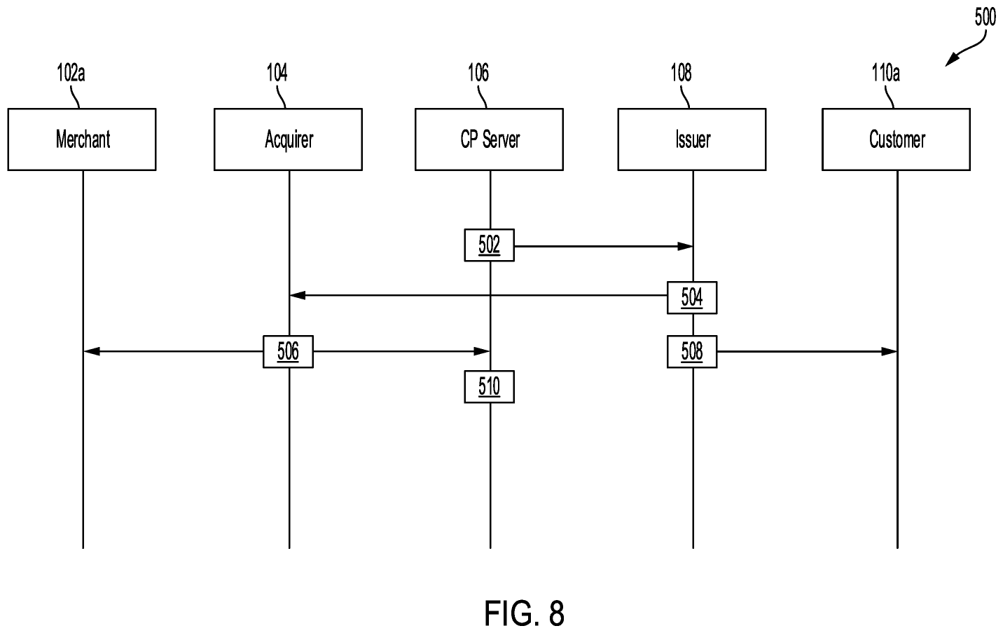

FIG. 8 shows a logic flow diagram of an auto-settlement process 500, according to at least one aspect of the present disclosure. In one aspect of the auto-settlement process 500, the central payment server 106 determines 502 a settlement type for a merchant device 102a. The central payment server 106 determines whether a settlement date for the auto-settlement is set by the merchant device 102a or is selected by the central payment server 106 within the settlement window. The central payment server 106 initiates the auto-settlement based on the trigger of a predetermined date in the settlement window 404. The central payment server 106 queries all customer transactions associated with the merchant device 102a (e.g., merchant ID) and a first transaction period 402 (e.g., the timestamp of transaction is within a first transaction window). The central payment server 106 generates settlement requests for each issuer system 108, 118, 128, based on the query of transaction records. The settlement requests may be generated as a single request for each issuer system 108, 118, 128 or may be generated for each customer device 110a-n. The single issuer system settlement request may comprise transaction requests for all customer devices 110a-n associated with the issuer systems 108, 118, 128.

In one aspect of the auto-settlement process 500, the issuer system 108 receives 504 the settlement request(s), determines the applicable customer accounts associated with the transactions, and pushes funds to merchant account at the acquirer system 104. In one example, the issuer system 108 may pull the funds directly from the customer accounts or may arrange to cover the settlement balance and assign an obligation to the customer account. The issuer system 108 verifies that the funds were successfully sent and received and updates customer account balances. In one aspect of the auto-settlement process 500, the acquirer system 104 verifies 506 the receipt of funds from the issuer system 108, and transmits a confirmation message to the central payment server 106. The confirmation message may include a list of all transactions settled by the issuer system 108. The acquirer system 104 may wait to send the confirmation message until a predetermined time period each day, so that multiple confirmation messages may be consolidated for each funding transfer received that day. In one aspect of the auto-settlement process 500, the issuer system 108 sends 508 a confirmation message to the customer device 110a associated with the funds transfer and the merchant device 102a. The confirmation message indicates that the merchant device 102a was paid in full for the transactions made during the first transaction period and the customer's owed balance to the merchant is $0. In one aspect of the auto-settlement process 500, central payment server 106 receives 510 a confirmation message from the acquirer system and updates the central ledger to indicate that a first set of transactions associated with the confirmation message were settled.

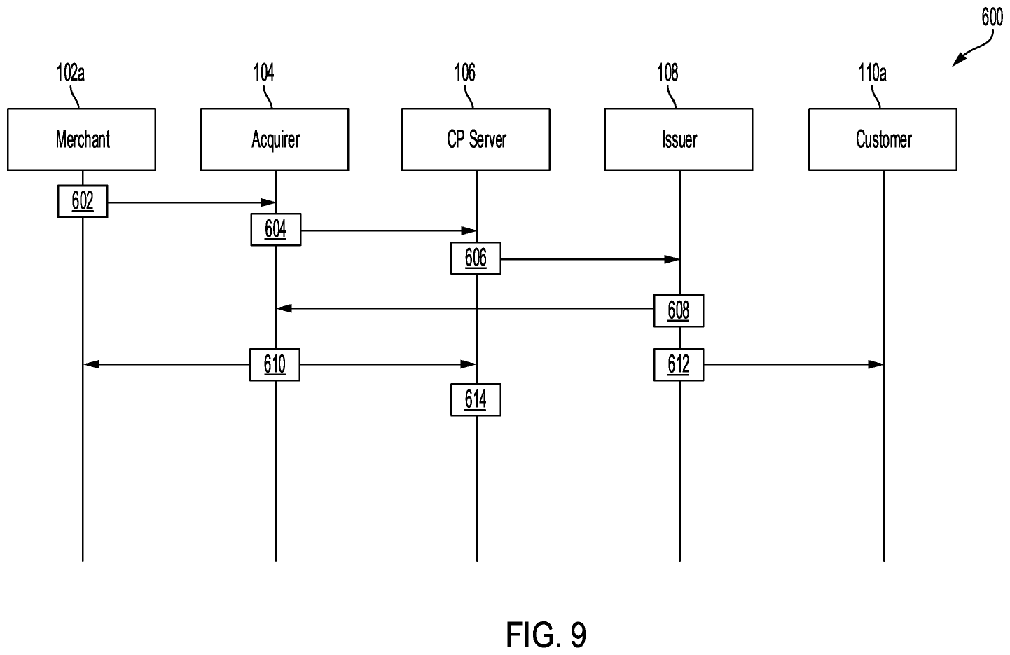

FIG. 9 shows a logic flow diagram of a merchant triggered manual settlement process 600, according to at least one aspect of the present disclosure. In one aspect of the merchant triggered manual settlement process 600, the merchant device 102a initiates 602 a manual settlement through the BNPL application. In one aspect of the merchant triggered manual settlement process 600, the acquirer system 104 receives 604 the request to perform the manual settlement. The acquirer system 104 may consolidate settlement requests from different merchant devices 102a-n and send multiple merchant requests in a batch process to the central payment server 106. In one aspect of the merchant triggered manual settlement process 600, the central payment server 106 determines 606 that the settlement type for the merchant device 102a is a manual settlement. The central payment server 106 determines a settlement date based on the received settlement request by the merchant device 102a or based on a default date if the merchant forgets to submit a settlement request during the settlement window/period. The central payment server 106 initiates the settlement based on the trigger of the settlement date in the settlement window 404. The central payment server 106 queries all customer transactions associated with the merchant device 102a (e.g., merchant ID) and a first transaction period (e.g., the timestamp of transaction is within a first transaction window). The central payment server 106 generates settlement requests for each issuer system 108, 118, 128, based on the query of transaction records. The settlement request may be generated as a single request for each issuer system 108, 118, 128 or may be generated for each customer device 110a-n. The single issuer system settlement request may comprise transaction for all customer devices 110a-n associated with the issuer systems 108, 118, 128.

In one aspect of the merchant triggered manual settlement process 600, the issuer system 108 receives 608 the settlement request(s), determines the applicable customer accounts associated with the transactions, and pushes funds to merchant account at the acquirer system 104. In one example, the issuer system 108 may pull the funds directly from the customer accounts or may arrange to cover the settlement balance and assign an obligation to the customer account. The issuer system 108 verifies that the funds were successfully sent and received and updates customer account balances. In one aspect of the merchant triggered manual settlement process 600, the acquirer system 104 verifies 610 the receipt of funds from the issuer system 108, and transmits a confirmation message to the central payment server 106. The confirmation message may include a list of all transactions settled by the issuer system 108. The acquirer system 104 may wait to send the confirmation message until a predetermined time period each day, so that the confirmation message is consolidated for each funding transfer received that day. In one aspect of the merchant triggered manual settlement process 600, the issuer system 108 sends 612 a confirmation message to the customer device 110a, indicating that the funds were pulled from the customer account and the merchant device 102a was paid in full for the transaction made during the first transaction period. In one aspect of the merchant triggered manual settlement process 600, central payment server 106 receives 614 a confirmation message from the acquirer system 104 and updates the central ledger 220 to indicate that a first set of transactions associated with the confirmation message were settled.

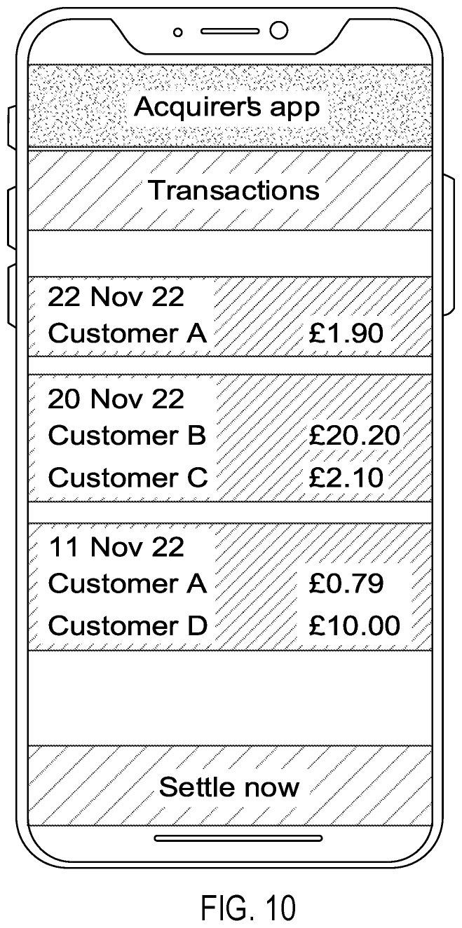

FIGS. 10-14 show examples of a graphical user interface for a BNPL application, for a merchant 102.

FIG. 10 shows a graphical user interface of a BNPL application configured for a merchant account on a mobile device, according to at least one aspect of the present disclosure. In this example, the merchant device 102a comprises a mobile device (e.g., smart phone, tablet, computing device, etc.) configured to access or deploy the BNPL application. The BNPL application displays a “settle now” selection option (e.g., button), based on the current date being within a settlement window. In one example, the “settle now” button may be grayed out until the settlement window is active. The BNPL application displays a list of transactions that are available for settlement. In one example, selection of the “settle now” option initiates a manual settlement for all of the transactions that are available for settlement.

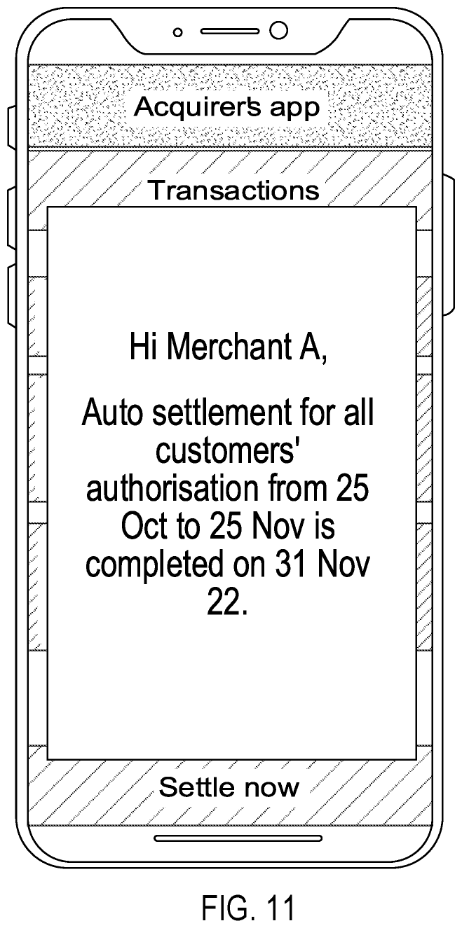

FIG. 11 shows an example notification, received by a merchant device 102a through the buy now pay later application, according to at least one aspect of the present disclosure. In this example, an auto-settlement process has been performed for all of the transactions made in the transaction period (e.g., October 25-November 25).

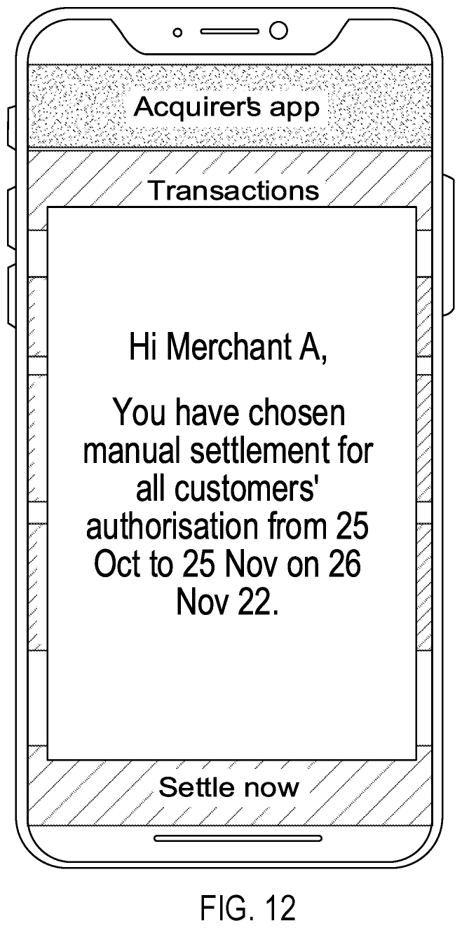

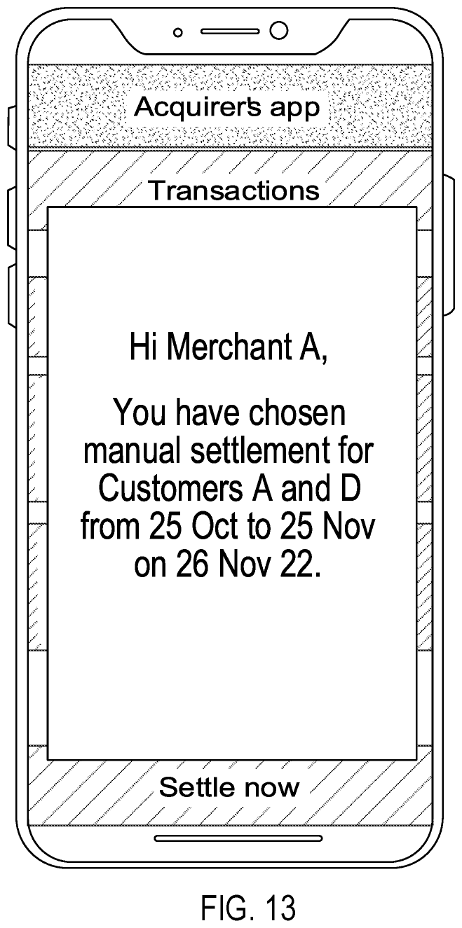

FIGS. 12 and 13 show example notifications, received by a merchant device 102a, through a buy now pay later application, in response to a “settle now” selection, according to at least one aspect of the present disclosure. FIG. 12 shows an example of a manual settlement process that is initiated for all available transactions made during the transaction period and may be the default option. FIG. 13 shows an example of a manual settlement process that is initiated for only selected customers within the transaction period. In this example, the merchant device 102a selects only the specific customers to initiate the settlement process. As shown in FIG. 10, if no customers are selected, the default option may initiate the settlement process for all transactions in the predefined transaction period.

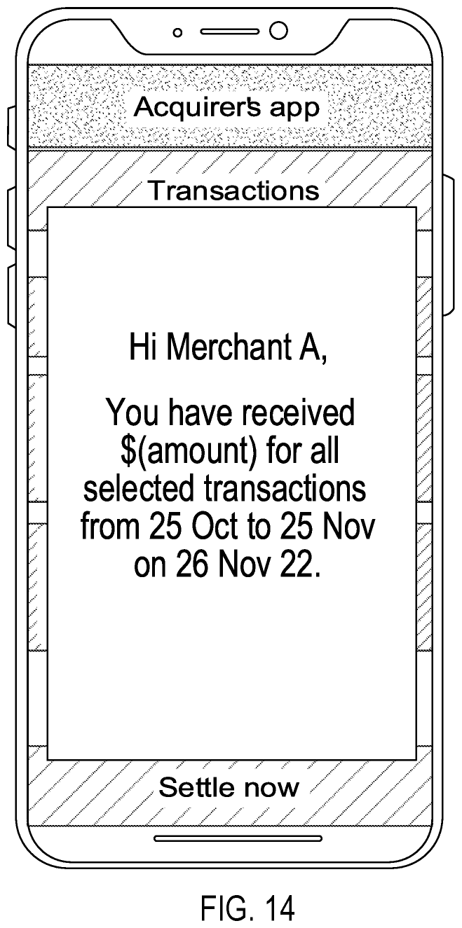

FIG. 14 shows an example notification, received by a merchant device 102a, through a buy now pay later application, according to at least one aspect of the present disclosure. The notification indicates that the acquirer system 104 has received all customer settlement amounts for the merchant, the merchant selected transaction during the transaction period.

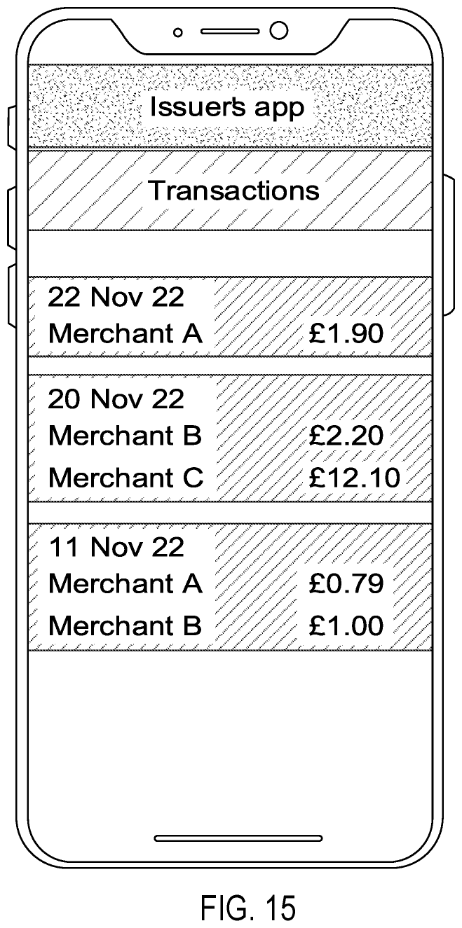

FIGS. 15-21 show examples of a graphical user interface for a buy now pay later application, for a customer device 110a. FIG. 15 shows a listing of all customer transactions made in a predefined period, according to at least one aspect of the present disclosure. In one example, a default view may display all transactions made within the last month. The customer device 110a may select the transaction to evaluate whether the transaction is pending for settlement, rejected or settled.

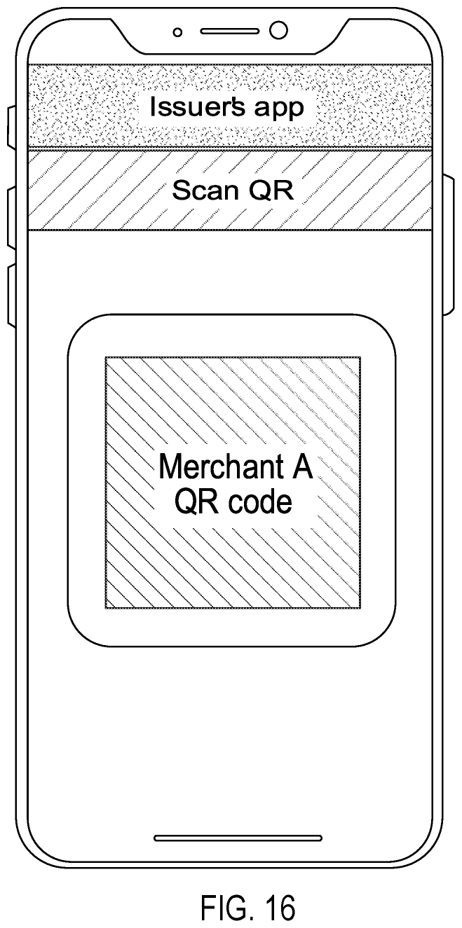

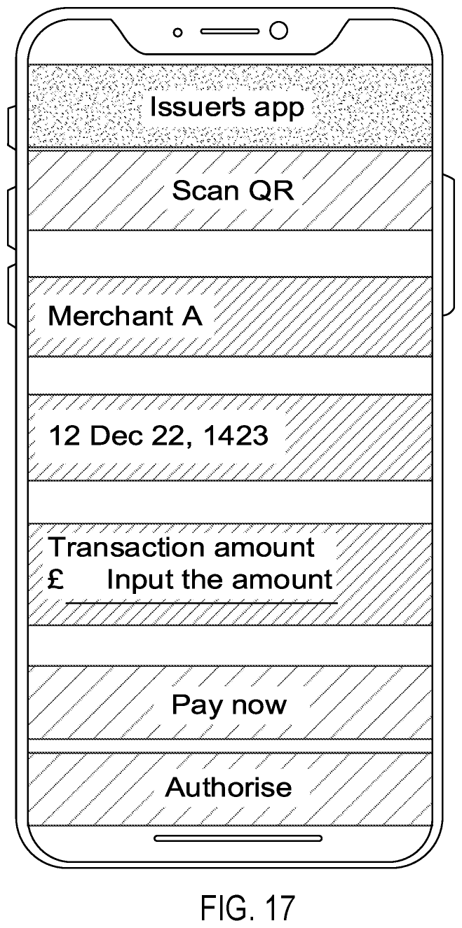

FIGS. 16 and 17 show a graphical user interface of a buy now pay later application configured to receive transaction information for a customer transaction, according to at least one aspect of the present disclosure. FIG. 16 shows a camera interface as part of the BNPL application, according to at least one aspect of the present disclosure. The customer device 110a scans the merchant QR code to initiate a new transaction. FIG. 17 shows a new transaction input prompt. The new transaction input prompt is displayed in response to scanning the merchant QR code. The merchant information may be automatically provided from the information in the QR code. A timestamp may indicate the time that the QR code is scanned. In one aspect, the customer device 110a or the merchant device 102a may input the transaction amount. The new transaction input prompt further displays selection options for paying now or authorizing the transaction. By selecting the authorization option, the customer agrees, at the time of the transaction, to pay the merchant device 102a at a later date of settlement. After the customer device 110a authorizes the transaction, the transaction information is sent to issuer system 108 associated with the customer device 110a. The issuer system 108 performs an additional transaction authorization and stores the transaction record in the central ledger 220 on the central payment server 106.

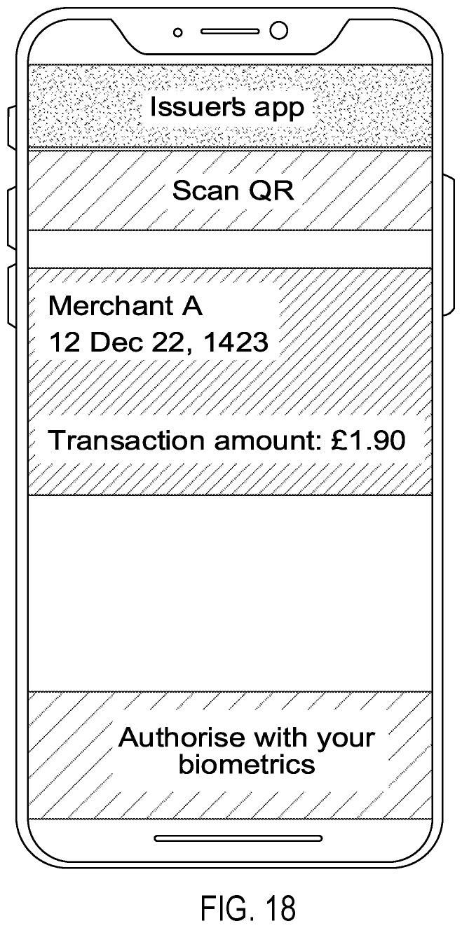

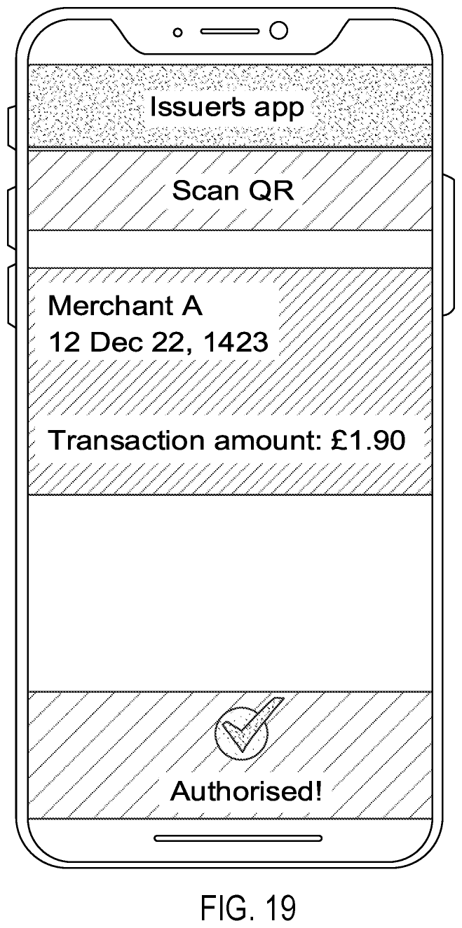

FIGS. 18 and 19 show a graphical user interface of a buy now pay later application configured to authorize a transaction request, by a customer device 110a, according to at least one aspect of the present disclosure. FIG. 18 shows a display prompt in the BNPL application, after the customer device 110a selects the authorize selection option (e.g., authorize button of FIG. 17). The display prompt shows a summary of the transaction and provides the customer device 110a with an option to authorize the transaction with biometric, or any suitable type of, identifying information (e.g., password, PIN, fingerprint, facial recognition, etc.). FIG. 19 shows a display prompt in the BNPL application, after the customer successful enters their identification information. In various aspects, the biometric information may include a fingerprint, face scan, or other biometric identifying information. Once biometric information is successfully identified, a status update may be displayed to show that the transaction was authorized by the customer device 110a and sent to the issuer system 108.

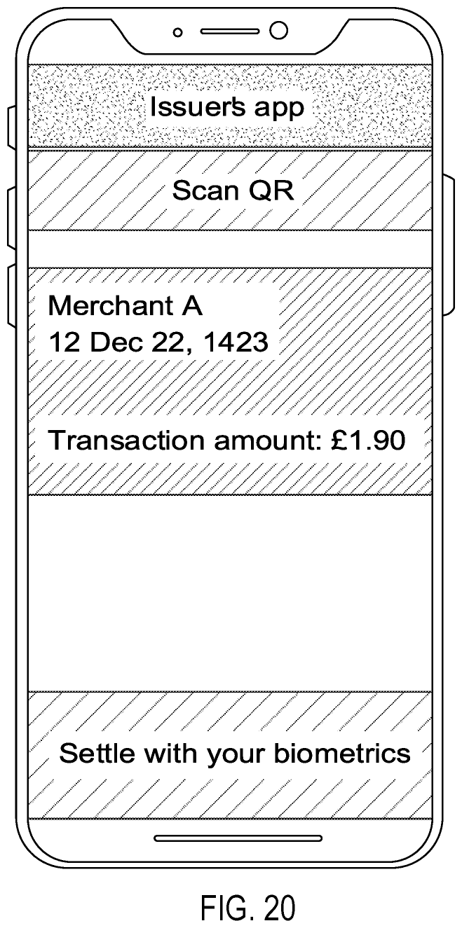

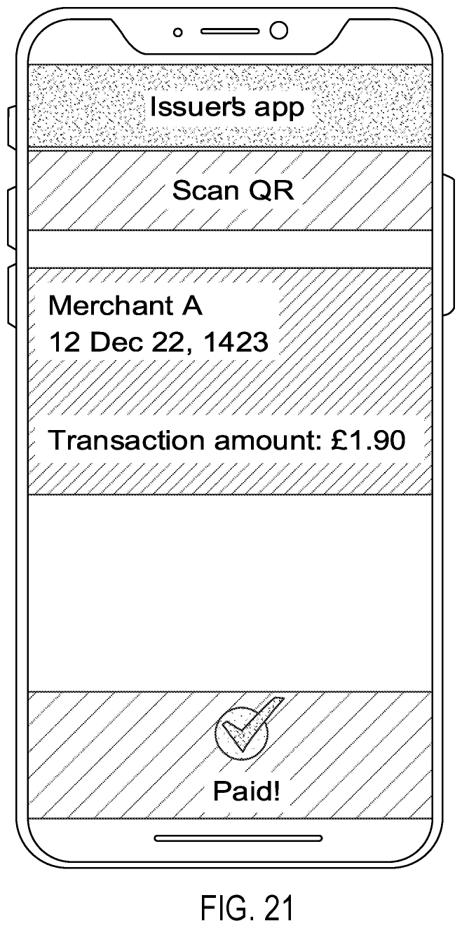

FIGS. 20 and 21 show a graphical user interface of a buy now pay later application configured to complete a pay now transaction, by a customer device 110a, according to at least one aspect of the present disclosure. FIG. 20 shows a display prompt in the BNPL application, after the customer device 110a selects the pay now selection option (e.g., pay now button of FIG. 17). The display prompt shows a summary of the transaction and provides the customer with an option to approve the pay now transaction with biometric identifying information. FIG. 21 shows a display prompt in the BNPL application, after the customer successfully enters their biometric information. Once biometric information is successfully identified, a status update may be displayed to show that the transaction was paid by the customer and sent to the issuer system for further approval.

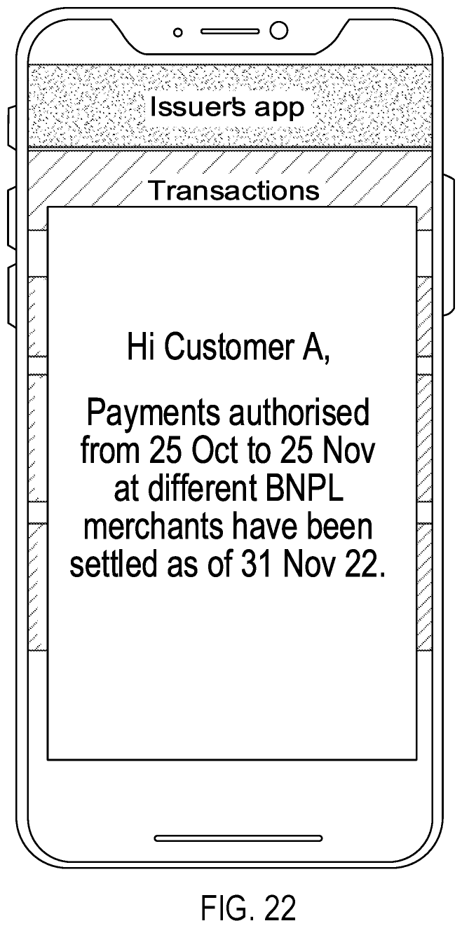

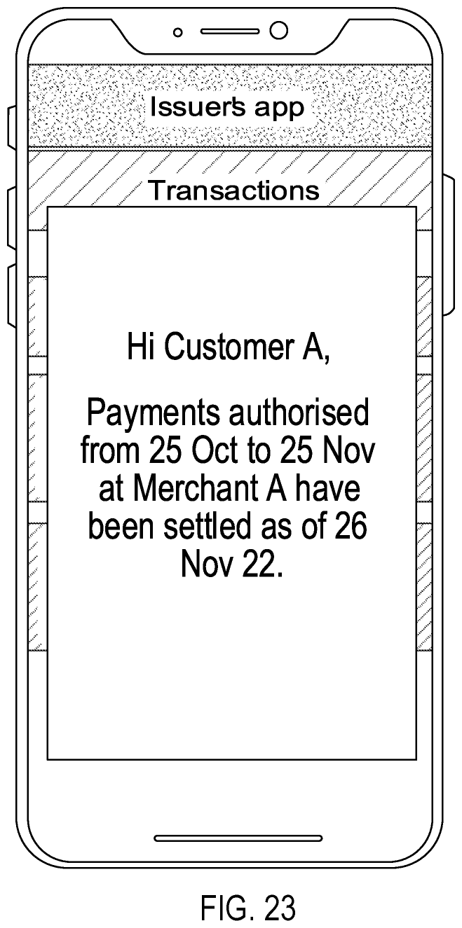

FIGS. 22 and 23 show a graphical user interface of a buy now pay later application configured to display a notification received by a customer device 110a in response to a transaction settlement, according to at least one aspect of the present disclosure. In one example, the customer device 110a receives a notification at the end of the month once their transactions are settled, regardless of whether settlement process was performed with the manual settlement or auto-settlement. The money may be deducted from the customer account because they have sufficient funds at the point of settlement or the issuer system may settle the transactions first and then settle the amount separately with the customer. FIG. 22 shows an example notification received by the customer for settlement by more than one merchant and FIG. 23 shows an example notification of settlement for a specific merchant device 102a.

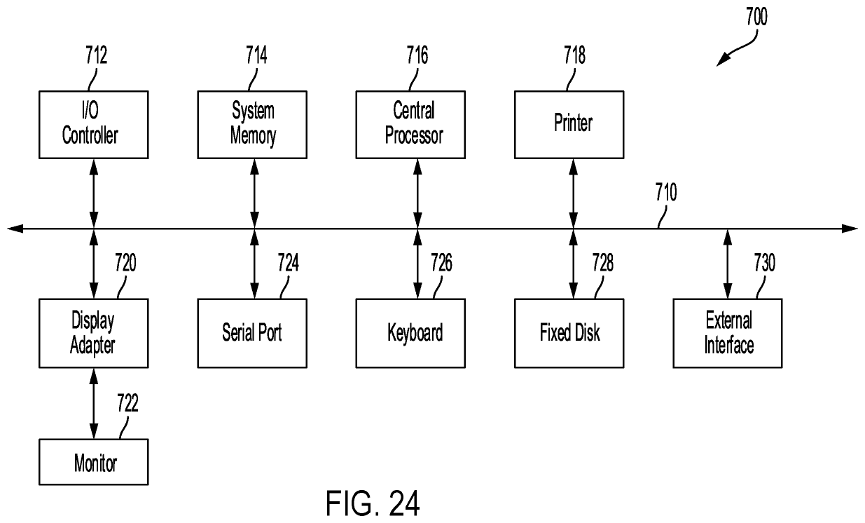

FIG. 24 is a block diagram of a computer apparatus 700 with data processing subsystems or components, according to at least one aspect of the present disclosure. The subsystems shown in FIG. 24 are interconnected via a system bus 710. Additional subsystems such as a printer 718, keyboard 726, fixed disk 728 (or other memory comprising computer readable media), monitor 722, which is coupled to a display adapter 720, and others are shown. Peripherals and input/output (I/O) devices, which couple to an I/O controller 712 (which can be a processor or other suitable controller), can be connected to the computer system by any number of means known in the art, such as a serial port 724. For example, the serial port 724 or external interface 730 can be used to connect the computer apparatus to a wide area network such as the Internet, a mouse input device, or a scanner. The interconnection via system bus allows the central processor 716 to communicate with each subsystem and to control the execution of instructions from system memory 714 or the fixed disk 728, as well as the exchange of information between subsystems. The system memory 714 and/or the fixed disk 728 may embody a computer readable medium.

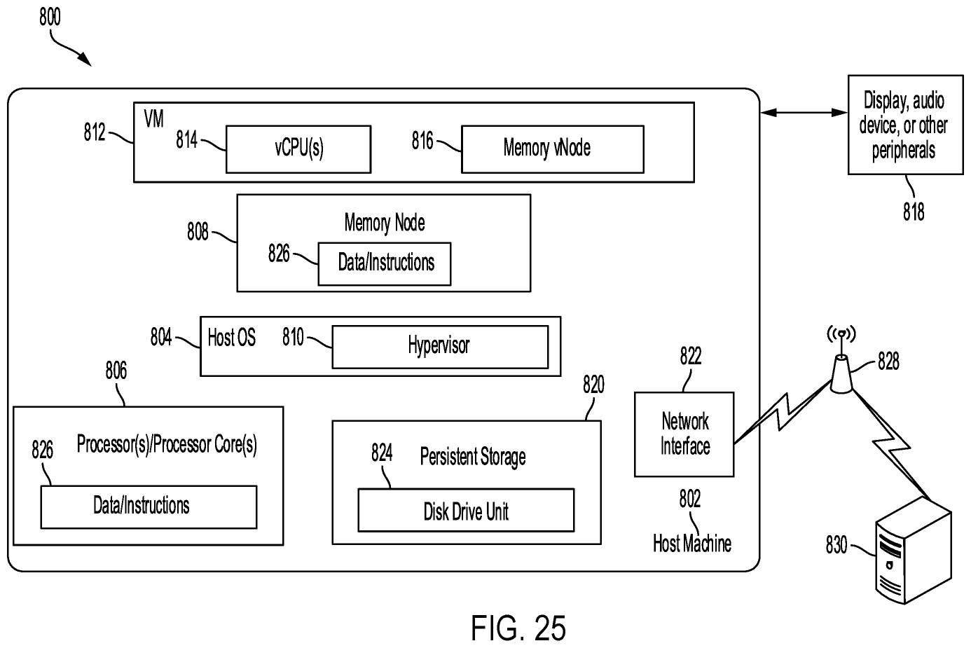

FIG. 25 is a diagrammatic representation of an example system 800 that includes a host machine 802 within which a set of instructions to perform any one or more of the methodologies discussed herein may be executed, according to at least one aspect of the present disclosure. In various aspects, the host machine 802 operates as a standalone device or may be connected (e.g., networked) to other machines. In a networked deployment, the host machine 802 may operate in the capacity of a server or a client machine in a server-client network environment, or as a peer machine in a peer-to-peer (or distributed) network environment. The host machine 802 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 800 includes the host machine 802, running a host operating system (OS) 804 on a processor or multiple processor(s)/processor core(s) 806 (e.g., a central processing unit (CPU), a graphics processing unit (GPU), or both), and various memory nodes 808. The host OS 804 may include a hypervisor 810 which is able to control the functions and/or communicate with a virtual machine (“VM”) 812 running on machine readable media. The VM 812 also may include a virtual CPU or vCPU 814. The memory nodes 808 may be linked or pinned to virtual memory nodes or vNodes 816. When the memory node 808 is linked or pinned to a corresponding vNode 816, then data may be mapped directly from the memory nodes 808 to their corresponding vNodes 816.

All the various components shown in host machine 802 may be connected with and to each other, or communicate to each other via a bus (not shown) or via other coupling or communication channels or mechanisms. The host machine 802 may further include a video display, audio device or other peripherals 818 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker) a persistent storage device 820 (also referred to as disk drive unit), and a network interface device 822. The host machine 802 may further include a data encryption module (not shown) to encrypt data. The components provided in the host machine 802 are those typically found in computer systems that may be suitable for use with aspects of the present disclosure and are intended to represent a broad category of such computer components that are known in the art. Thus, the system 800 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 824 also may be a Solid-state Drive (SSD), a hard disk drive (HDD) or other includes a computer or machine-readable medium on which is stored one or more sets of instructions and data structures (e.g., data/instructions 826) embodying or utilizing any one or more of the methodologies or functions described herein. The data/instructions 826 also may reside, completely or at least partially, within the main memory node 808 and/or within the processor(s) 806 during execution thereof by the host machine 802. The data/instructions 826 may further be transmitted or received over a network 828 via the network interface device 822 utilizing any one of several well-known transfer protocols (e.g., Hyper Text Transfer Protocol (HTTP)).

The processor(s) 806 and memory nodes 808 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 802 and that causes the host machine 802 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 830 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 802, with each server 830 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. method for settling a central ledger in a central payment system, the method comprising: determining, by a computing system, a settlement type associated with a merchant device; determining, by the computing system, a settlement date associated with the settlement type, wherein the settlement date is within a settlement window associated with a transaction period for the merchant device; determining, by the computing system, a set of transactions made in the transaction period, wherein the set of transactions are associated with an issuer system; transmitting, by the computing system, a settlement request to the issuer system, wherein the settlement request prompts the issuer system to push funds to an acquirer system associated with the merchant device; receiving, by the computing system, a confirmation message from the acquirer system that they have received funds associated with the set of transactions, from the issuer system; updating, by the computer system, a transaction status for the set of transactions in a central ledger, wherein the transaction status is updated in response to the confirmation message received by the acquirer system; and notifying, by the computer system, the merchant device that funds were received by the acquirer system associated with the set of transactions.

Clause 2. The method of Clause 1, wherein the settlement window comprises a range of permissible dates for initiation of the settlement request, and wherein the settlement window and the transaction period are non-concurrent periods.

Clause 3. The method of Clauses 1-2, further comprising: determining, by the computer system, the settlement type is an automatic settlement, wherein the merchant device sets an auto-settlement date within the settlement window as the settlement date.

Clause 4. The method of Clause 3, wherein the auto-settlement date is a predetermined number of days after the transaction period is closed that falls within the settlement window.

Clause 5. The method of Clauses 1-4, further comprising: determining, by the computer system, the settlement type is an automatic settlement; determining, by the computer system, the merchant device does not set an auto-settlement date for the settlement date; and selecting, by the computer system, the settlement date within the settlement window associated with the transaction period for the merchant device.

Clause 6. The method of Clauses 1-5, further comprising: determining, by the computer system, the settlement type is a manual settlement; and determining, by the computer system, the settlement date for a manual settlement based on a merchant device request to perform the manual settlement, wherein a timestamp of the merchant device request to perform the manual settlement is assigned as the settlement date.

Clause 7. The method of Clauses 1-6, further comprising: determining, by the computer system, the settlement type is a manual settlement; determining, by the computer system, that a present date is the last day in the settlement window and the merchant device has not provided a settlement date for the manual settlement; and assigning, by the computer system, the present date as the settlement date, based on determining that the settlement date was not provided by the merchant device for the manual settlement.

Clause 8. The method of Clauses 1-7, wherein the settlement request prompts the issuer system to cover a settlement balance of a first transaction in the set of transactions, wherein the first transaction is associated with a first customer account at the issuer system, and wherein an account balance of the first customer account is insufficient to settle the settlement balance associated with the first transaction.

Clause 9. The method of Clauses 1-8, wherein the settlement request prompts the issuer system to pull a settlement balance directly from a first customer account, wherein the settlement balance is associated with a first transaction in the set of transactions, wherein the first transaction is associated with the first customer account at the issuer system, and wherein an account balance of the first customer account is sufficient to settle the settlement balance associated with the first transaction.

Clause 10. A method for settling a central ledger in a central payment system, the method comprising: receiving, by a computing system, a settlement date from a merchant device, wherein the settlement date is within a settlement window associated with a transaction period for the merchant device; determining, by the computing system, a set of transactions made in the transaction period, wherein the set of transactions are associated with an issuer system; transmitting, by the computing system, a settlement request to the issuer system, wherein the settlement request prompts the issuer system to push funds to an acquirer system associated with the merchant device; receiving, by the computing system, a confirmation message from the acquirer system indicating receipt of funds associated with the set of transactions, from the issuer system; updating, by the computing system, a transaction status for the set of transactions in the central ledger, wherein the transaction status is updated in response to the confirmation message received from the acquirer system; and notifying, by the computer system, the merchant device that funds were received by the acquirer system associated with the set of transactions.

Clause 11. The method of Clause 10, wherein the settlement window comprises a range of permissible dates for initiation of the settlement request, and wherein the settlement window and the transaction period are non-concurrent.

Clause 12. The method of Clause 10-12, wherein the settlement request prompts the issuer system to cover a settlement balance of a first transaction in the set of transactions, wherein the first transaction is associated with a first customer account at the issuer system, wherein an account balance of the first customer account is insufficient to settle the settlement balance associated with the first transaction.

Clause 13. The method of Clause 10-13, wherein the settlement request prompts the issuer system to pull a settlement balance directly from a first customer account, wherein the settlement balance is associated with a first transaction in the set of transactions, wherein the first transaction is associated with the first customer account at the issuer system, wherein an account balance of the first customer account is sufficient to settle the settlement balance associated with the first transaction.

Clause 14. A method for settling a central ledger in a central payment system, the method comprising: receiving, by a computing system, transaction records associated with transaction requests made by a plurality of customer devices; recording, by the computing system, the transaction records in the central ledger; performing, by the computing system, a periodic settlement query on the central ledger based on a predetermined transaction period associated with a merchant identifier of a merchant device; transmitting, by the computing system, a settlement request to a plurality of issuer systems corresponding to the plurality of customer devices, wherein the settlement request is based on the periodic settlement query; receiving, by the computing system, a settlement confirmation from an acquirer system corresponding to the merchant device, wherein the settlement confirmation indicated that settlement funds were deposited in an account associated with the merchant device; and updating, by the computing system, the central ledger associated with the plurality of customer devices based on the settlement confirmation.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for settling a central ledger in a central payment system, the method comprising:
determining, by a computing system, a settlement type associated with a merchant device;
determining, by the computing system, a settlement date associated with the settlement type, wherein the settlement date is within a settlement window associated with a transaction period for the merchant device;
determining, by the computing system, a set of transactions made in the transaction period, wherein the set of transactions are associated with an issuer system;
transmitting, by the computing system, a settlement request to the issuer system, wherein the settlement request prompts the issuer system to push funds to an acquirer system associated with the merchant device;
receiving, by the computing system, a confirmation message from the acquirer system that they have received funds associated with the set of transactions, from the issuer system;
updating, by the computer system, a transaction status for the set of transactions in a central ledger, wherein the transaction status is updated based on to the confirmation message received by the acquirer system; and
notifying, by the computer system, the merchant device that funds were received by the acquirer system associated with the set of transactions.

2. The method of claim 1, further comprising:
notifying, by the computer system, a user device associated with the transaction status for the set of transactions in the central ledger, that the transaction status is updated.

3. The method of claim 1, wherein the settlement window comprises a range of permissible dates for initiation of the settlement request, and wherein the settlement window and the transaction period are non-concurrent periods.

4. The method of claim 1, further comprising: determining, by the computer system, the settlement type is an automatic settlement, wherein the merchant device sets an auto-settlement date within the settlement window as the settlement date.

5. The method of claim 4, wherein the auto-settlement date is a predetermined number of days after the transaction period is closed that falls within the settlement window.

6. The method of claim 1, further comprising:
determining, by the computer system, the settlement type is an automatic settlement;
determining, by the computer system, the merchant device does not set an auto-settlement date for the settlement date; and
selecting, by the computer system, the settlement date within the settlement window associated with the transaction period for the merchant device.

7. The method of claim 1, further comprising:
determining, by the computer system, the settlement type is a manual settlement; and
determining, by the computer system, the settlement date for a manual settlement based on a merchant device request to perform the manual settlement, wherein a timestamp of the merchant device request to perform the manual settlement is assigned as the settlement date.

8. The method of claim 1, further comprising:
determining, by the computer system, the settlement type is a manual settlement;
determining, by the computer system, that a present date is the last day in the settlement window and the merchant device has not provided a settlement date for the manual settlement; and
assigning, by the computer system, the present date as the settlement date, based on determining that the settlement date was not provided by the merchant device for the manual settlement.

9. The method of claim 1, wherein the settlement request prompts the issuer system to cover a settlement balance of a first transaction in the set of transactions, wherein the first transaction is associated with a first customer account at the issuer system, and wherein an account balance of the first customer account is insufficient to settle the settlement balance associated with the first transaction.

10. The method of claim 9, further comprising:
transmitting, by the computer system, a notification to a user device associated with the first customer account at the issuer system, wherein the notification indicates that the first customer account is insufficient to settle the settlement balance associated with the first transaction and the settlement balance of the first transaction was covered by the issuer system.

11. The method of claim 1, wherein the settlement request prompts the issuer system to pull a settlement balance directly from a first customer account, wherein the settlement balance is associated with a first transaction in the set of transactions, wherein the first transaction is associated with the first customer account at the issuer system, and wherein an account balance of the first customer account is sufficient to settle the settlement balance associated with the first transaction.

12. A method for settling a central ledger in a central payment system, the method comprising:
receiving, by a computing system, a settlement date from a merchant device, wherein the settlement date is within a settlement window associated with a transaction period for the merchant device;
determining, by the computing system, a set of transactions made in the transaction period, wherein the set of transactions are associated with an issuer system;
transmitting, by the computing system, a settlement request to the issuer system, wherein the settlement request prompts the issuer system to push funds to an acquirer system associated with the merchant device;
receiving, by the computing system, a confirmation message from the acquirer system indicating receipt of funds associated with the set of transactions, from the issuer system;
updating, by the computing system, a transaction status for the set of transactions in the central ledger, wherein the transaction status is updated in response to the confirmation message received from the acquirer system; and
notifying, by the computer system, the merchant device that funds were received by the acquirer system associated with the set of transactions.

13. The method of claim 12, further comprising:
notifying, by the computer system, a user device associated with the transaction status for the set of transactions in the central ledger, that the transaction status is updated.

14. The method of claim 12, wherein the settlement window comprises a range of permissible dates for initiation of the settlement request, and wherein the settlement window and the transaction period are non-concurrent.

15. The method of claim 12, wherein the settlement request prompts the issuer system to cover a settlement balance of a first transaction in the set of transactions, wherein the first transaction is associated with a first customer account at the issuer system, wherein an account balance of the first customer account is insufficient to settle the settlement balance associated with the first transaction.

16. The method of claim 15, further comprising: transmitting, by the computer system, a notification to a user device associated with the first customer account at the issuer system, wherein the notification indicates that the first customer account is insufficient to settle the settlement balance associated with the first transaction and the settlement balance of the first transaction was covered by the issuer system.

17. The method of claim 12, wherein the settlement request prompts the issuer system to pull a settlement balance directly from a first customer account, wherein the settlement balance is associated with a first transaction in the set of transactions, wherein the first transaction is associated with the first customer account at the issuer system, wherein an account balance of the first customer account is sufficient to settle the settlement balance associated with the first transaction.

18. A method for settling a central ledger in a central payment system, the method comprising:
receiving, by a computing system, transaction records associated with transaction requests made by a plurality of customer devices;
recording, by the computing system, the transaction records in the central ledger;
performing, by the computing system, a periodic settlement query on the central ledger based on a predetermined transaction period associated with a merchant identifier of a merchant device;
transmitting, by the computing system, a settlement request to a plurality of issuer systems corresponding to the plurality of customer devices, wherein the settlement request is based on the periodic settlement query;
receiving, by the computing system, a settlement confirmation from an acquirer system corresponding to the merchant device, wherein the settlement confirmation indicated that settlement funds were deposited in an account associated with the merchant device; and
updating, by the computing system, the central ledger associated with the plurality of customer devices based on the settlement confirmation.

19. The method of claim 16, wherein the settlement window comprises a range of permissible dates for initiation of the settlement request, and wherein the settlement window and the transaction period are non-concurrent periods.

20. The method of claim 16, wherein the settlement request prompts the issuer system to cover a settlement balance of a first transaction in the set of transactions, wherein the first transaction is associated with a first customer account at the issuer system, wherein an account balance of the first customer account is insufficient to settle the settlement balance associated with the first transaction.
